(19) United States
(12) Patent Application Publication
(10) Pub. No.: US 2004/0256180 A1
(43) Pub. Date: Dec. 23, 2004

(54) Elevator for transporting a load by means of a movable traction means

(76) Inventors: Roland Eichhorn, Oberkulm (CH); Ernst Ach, Ebikon (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/868,616

(22) Filed: Jun. 15, 2004

(30) Foreign Application Priority Data
Jun. 19, 2003 (EP) 03405444.5

(51) Int. Cl. B66B 11/08

(52) U.S. Cl. 187/254

(57) ABSTRACT

A load transporting apparatus includes a movable traction device connected with the load and having a section in contact with at least one roller in order to guide the traction device. The roller has a coating on a carrier for contact with the traction device section. A coefficient of friction between the traction device and the coating is less than the corresponding coefficient of friction for contact between the traction device and the carrier. The coating reduces or avoids, on movement of the traction device relative to the roller, torsion of the traction device about a longitudinal axis and/or deformation of the traction device transversely to the direction of movement, particularly in the case of movement of the traction device obliquely with respect to the longitudinal direction thereof, and reduces the sensitivity of the traction device to wear, particularly when the traction means is under diagonal tension.

### BACKGROUND OF THE INVENTION

The present invention relates to an elevator for transporting at least one load by means of at least one movable traction means.

As a known example for an elevator of that kind there can be considered, inter alia, a conventional elevator installation in which a load, for example an elevator car, or also several loads, for example an elevator car and a counterweight for compensation of the weight of the elevator car, are suspended at at least one support means. One or more cables and/or one or more belts usually serve as the support means. The respective support means are in that case connected with the respective loads in such a manner that in the case of movement of the support means the respective loads are transported, for example between different floors of a building. In the present case, a support means has also the function of a traction means.

In the following, if not otherwise specified, the term ‘traction means’ is also used as a designation for a traction means which is designed as support and traction means for a load.

In the past, a number of arrangements for traction means for the transport of loads were proposed, in which each traction means is brought into contact with at least one body in order to guide the traction means. The contact with the respective body limits the movement play of the traction means and thus affects guidance of the traction means. The boundary surface between the traction means and the body is in that case of great significance for the efficiency of the respective arrangement. The form of boundary surface influences, for example, the friction between the traction means and the body and influences wear phenomena, which can be caused by the contact between the traction means and the body. Bodies can be used which have a coating at places at which the traction means is disposed in contact with the body. Contact between the body and the traction means can be optimized by a suitable choice of a coating.

In conventional elevator installations the traction means for elevator cars or counterweights are, for example, usually brought into contact with at least one roller and/or at least one slide element. The roller or slide element in that case has an influence on the instantaneous physical arrangement of the traction means and, in particular, on movement of a longitudinal section of the traction means not only in a longitudinal direction, but also in a transverse direction of the longitudinal section.

In conventional elevator installations, rollers are usually used for different purposes, for example as drive rollers or also as deflecting rollers for the respective traction means.

A drive roller can be set into rotation by a drive and usually has the task of moving a traction means. For this purpose the support roller is arranged with respect to the traction means in such a manner that the traction means stands in contact with a surface of the drive roller, which surface is moved when the drive roller is rotated, and that traction forces are transmitted to the traction means in the case of movement of the surface. The drive roller is usually oriented in such a manner that a longitudinal section of the traction means is aligned substantially parallel to the direction in which the surface is movable. Under this condition the force transmission between drive roller and traction means in longitudinal direction of the traction means is optimal. This configuration is obviously particularly well suited for achieving movement of the traction means in the longitudinal direction thereof. In order to achieve a high level of traction the traction means is as a rule arranged in such a manner that it loops around the drive roller along a circular circumferential line about an axis of rotation of the drive roller partly or even entirely or more than once. In this form of guidance of the traction means, the length direction of the traction means accordingly changes at the drive roller.

By contrast to drive rollers, deflecting rollers are not provided with a drive and accordingly are not suitable for driving a traction means. Rather, a torque is transmissible to a deflecting roller by a traction means which is brought into contact with the deflecting roller along a circumferential line about the axis of rotation of the deflecting roller and the deflecting roller can thus be set into rotation when the traction means is moved. Deflecting rollers are usually brought into contact with a traction means in such a manner that the traction means partly or even entirely loops around the deflecting roller along a circular circumferential line about the axis of rotation thereof.

Deflecting rollers are used in elevator installations for various purposes. In the case of typical use, a deflecting roller is installed in fixed position with respect to a stationary support structure of the elevator installation in order to deflect different length sections of a traction means in different directions. Forces engaging at the traction means are in that case conducted into the support structure of the elevator installation at least partly by way of the bearing of the rotational axle of the deflecting roller. In the case for another typical use, one or more deflecting rollers are employed in order to suspend a load in looping, which is formed by a length section of the traction means, around the deflecting rollers. In this case a relative movement between deflecting rollers and traction means and thus transport of the load are achieved by movement of the traction means in the longitudinal direction thereof.

A number of proposals are known which are directed to optimization of the boundary surfaces between a traction means and a roller. The optimizations are usually targeted to an increase in traction between traction means and roller.

By way of example, there is shown in U.S. Pat. No. 3,838,752 an elevator installation in which cables connecting an elevator car and a counterweight are guided by grooves of a drive roller. Lubricants are applied to the boundary surfaces between the cables and the drive roller and increase the coefficient of friction for the contact between one of the cables and the drive roller by comparison with the coefficient of friction for corresponding contact without lubricant. In this case the lubricant ensures an increase in the traction forces between the drive roller and the cables.

Patent Application WO 02/074677 shows an elevator installation with a drive roller for cables. The drive roller comprises a roller body, in which several grooves for guidance of the cables are impressed along a circumferential line, and a coating, for example a rubber or polyurethane, coated on the roller body. The coating produces—by comparison with the roller body—an increased friction between the drive roller and the cables and thus an enhancement of the traction forces between the drive roller and the cables.

European Patent Application EP 1096176 A1 discloses a drive roller for driving synthetic fiber cables, preferably for a cable drive of an elevator installation. The drive roller has grooves by which cables are guided. The groove surfaces, which stand in contact with the cables, are prepared in such a manner that they have—either due to a mechanical processing or due to the application of a suitable coating—a defined surface roughness. The surface roughness produces an increase in the coefficient of friction for contact between the cables and the drive pulleys compared with an unprocessed or uncoated drive roller. The traction forces transmissible between the drive roller and the cables are thus increased.

In order to achieve high traction forces between a roller and a traction means—for example a cable or a belt—which bears against the roller, several possibilities are available to the expert:

(i) the respective materials of the parts of the traction means and the roller disposed in contact with one another can be suitably selected in order to achieve a highest possible friction; and

(ii) the pressing force between the traction means and the roller can be selected to be as large as possible.

The possibilities (i) and (ii) can be used each time within a certain scope for optimization.

If, for example, the roller is of steel and the traction means is a cable, the outer surface of which is formed by steel wires, then a relatively low coefficient of friction is present in the contact between the cable and the roller. Since, however, wires of steel can be loaded to a high degree transversely to the direction of their length, use can be made of the possibility of choosing the pressing force between the cable and the roller to be particularly large. For this purpose, for example, the cable can be guided at the surface of the roller in a groove which is so dimensioned that the cable is clamped in place in transverse direction. Alternatively or additionally the groove can be so formed that the cable at the base of the groove rests on a smallest possible, sharp-edged support surface.

In departure from this example, significant other conditions are present in the case of traction means which contain load-bearing cables of synthetic material, for example, aramide. Whereas fibers of that kind are of low weight and can be highly loaded in the longitudinal direction thereof, these are capable of a far smaller loading in the transverse direction thereof than steel wires and are susceptible to damage by so-termed transverse forces, i.e. forces acting transversely to the longitudinal direction. Since a traction means in the case of contact with the roller and in the case of transmission of traction forces between the traction means and the roller can be exposed to high transverse forces there has been success, as traction means with load-bearing fibers of a synthetic material, with traction means in which the fibers are protected by a sheathing. By way of example, cables of aramide are known which consist of a core cable, which is formed by twisting several strands of aramide fibers, and a cable casing surrounding the core cable in its entirety. Resilient materials, for example elastomers such as polyurethane or rubber, above all have proved themselves as material for the cable casing. As an alternative to cables of that kind, there are known cables which are created by twisting several strands formed from synthetic fibers, wherein the strands each individually have a protective sheathing, for example of elastomers such as polyurethane or rubber. In this alternative, as well, the strands are, in the case of a suitable dimensioning of the sheathing of the individual strands, effectively protected against damage by transverse forces.

The mentioned synthetic fiber cables provided with a sheathing have the characteristic that the materials usually suitable for a sheathing have a relatively high coefficient of friction for contact with the usual materials used for rollers (for example steel or cast iron). This can be regarded as an advantage in different respects. For example, in the case of contact between one of these cables and a conventional drive roller relatively large traction forces can be transmitted even when relatively small pressing forces act between cable and roller. It is accordingly usually possible to dispense with additional measures increasing the pressing forces between cable and roller (for example, support of the cable on small, sharp-edged support surfaces or clamping of the cable in place in a narrow groove). Due to the high coefficient of friction for contact between the sheathing and a conventional drive roller a cable has to loop around the conventional drive roller only along a relatively short path in order to transmit sufficiently large traction forces. Accordingly, sufficiently large traction forces can be achieved with drive rollers which have a relatively small diameter. Accordingly, relatively low torques have to be exerted for the drive of rollers of that kind. Consequently, relatively small motors are sufficient to drive such rollers. This advantage can be utilized to a high degree in the case of employment of synthetic fiber cables, since synthetic fiber cables are usually flexible to a high degree and can accordingly be guided along tracks with a relatively small radius of curvature.

Recently, belts have also been used as traction means in elevator installations. These belts usually contain several load-bearing elements arranged in the longitudinal direction of the belt, for example elements of wire or strands of synthetic fibers. The load-bearing elements are in turn usually embedded in a casing of a resilient material. Polyurethane or rubber as a rule finds use as the material for the casing. Belts of that kind have the advantage that they can have a high degree of flexibility in the direction which a belt has the smallest extent transversely to the longitudinal direction. The high flexibility makes it possible to use rollers with a small diameter as drive rollers. However, limits are placed on miniaturization of drive rollers due to the fact that for transmission of sufficiently high traction forces between a drive roller and a belt a sufficiently large contact area has to be present between the belt and the drive roller. The contact area can be selected to be smaller the higher the coefficient of friction for contact between the belt and the drive roller. If the contact area is too small and/or the coefficient of friction too low, the risk then exists that the belt on rotation of the drive roller slips at the contact surface. With respect to miniaturization of drive rollers and drives for drive rollers it is therefore of advantage if the casing of a belt guarantees a high coefficient of friction.

The desire for miniaturization of the components employed is a significant driving force in the development of elevator installations and other devices for transporting loads, especially because miniaturization of individual components enables development of ever more efficient devices with a reduced requirement for space and thus creates the basis for reductions in cost.

The trend towards miniaturization has, however, in recent times led to realization of extreme operating conditions, which exhibit problematic side effects.

Arrangements of traction means which are moved for the transport of the load frequently exhibit instabilities which are connected with movements of a traction means transversely to the direction of its longitudinal extent.

In the case of elevators with conventional synthetic fiber cables as traction means there is manifested, for example, a high degree of sensitivity of these cables to diagonal tension. If a synthetic fiber cable moved in its longitudinal direction is, for example, in contact with a rotating roller and if the cable is so guided that the cable moves at the surface of the roller not within a plane perpendicular to the axis of rotation of the roller, but rather at an angle to this plane, thus moves under ‘diagonal tension’, then twistings of the cable about its longitudinal direction arise in operation. Such twistings in continuous operation are frequently not reversible. Twisting of a cable can increase in continuous operation in such a manner that the strands of the cable are damaged. This effect can drastically reduce the service life of the cable and lead to premature breakdown of an elevator.

This effect is frequently particularly disturbing in the case of synthetic fiber cables since these, due to the mechanical characteristics of usual synthetic fibers, do not have a high stiffness against torsion.

However, an excessive sensitivity to diagonal tension is limiting. On the one hand, complete avoidance of diagonal tension presupposes high demands on maintenance of tolerances with respect to the guidance of tension means and the arrangement of the surfaces with which the tension means are in contact. On the other hand, there are, for example in elevator construction, endeavors to take diagonal tension of traction means selectively into account in order to improve, through a special geometry of the guidance of the traction means, the utilization of space in an elevator shaft. The employment of design concepts of that kind is limited if the provided traction means exhibit a high degree of sensitivity relative to diagonal tension.

In the case of elevator installations in which the elevator cars and the counterweights are moved by a belt running over a drive roller and/or one or more deflecting rollers, in certain circumstances the effect can be observed of the belt wandering back and forth laterally—i.e., in direction of the axes of rotation of the respective rollers—in more or less uncontrolled manner on the surfaces of the respective rollers and thus exhibit a lateral movement with respect to the running direction of the belt, i.e. the length direction of the belt. In this case the belt is not guided in stable manner solely by the part of the roller surface on which it rests. In order to provide better lateral guidance of a belt there can be used rollers with grooves in which a support surface for a belt is formed in each instance by the base of a groove. In this case the flanks of the groove each act as a lateral boundary for a belt in order to confine lateral movement of the belt. However, in practice it has proved that a lateral guidance of the belt by groove flanks is accompanied by new problems. Belts can, in fact, interact with the groove flanks in different ways. For example, a belt can display wear phenomena particularly at places which come into contact with the groove flanks in continuous operation. Deformations of the belt can be produced with the contact with the groove flanks. These deformations can lead to unstable running of the belt. For example, it can happen that the belt when running through the groove suddenly wanders out over the groove flank and leaves the groove. That kind of behavior of a belt would be unacceptable in an elevator installation, since operational safety would not be guaranteed.

### SUMMARY OF THE INVENTION

Proceeding from the problem stated in the foregoing the present invention has the object of creating an elevator for transporting a load in which the traction means moved for transporting a load are guided in the gentlest manner possible.

The elevator according to the present invention comprises at least one movable traction means connected with a load, wherein at least one section of the traction means is brought into contact with at least one roller in order to guide the traction means. The roller comprises a coating and a rotatably mounted roller body which serves as a carrier of the coating, wherein the traction means can be brought into contact with the coating. According to the present invention the coating is selected in such a manner that a coefficient of friction for contact between the traction means and the coating is less than the corresponding coefficient of friction for contact between the traction means and the carrier.

The use of a suitable coating allows particularly low coefficients of friction for contact between the traction means and the roller to be achieved. In the selection of materials suitable as coating there are, in fact, fewer restrictions to be considered than in the selection of the carrier of the coating. For example, the carrier of the coating substantially determines the mechanical strength of the roller and thus the magnitude of the maximum force that can be accepted by the roller by virtue of the contact with the traction means. The coating, therefore, does not have to make a substantial contribution to the mechanical rigidity of the roller and can in the first instance be optimized with respect to the coefficient of friction for contact between the traction means and the coating. Accordingly, starting out from a suitable material for a carrier a suitable coating for the carrier can usually be found which, by comparison with the uncoated carrier, guarantees a friction-reducing effect.

The friction-reducing effect can have, inter alia, the consequence that in the case of contact of a traction means with the coating such forces which act when the traction means moves transversely to the directional movement of the traction means are reduced by comparison with contact between the traction means and the carrier. Due to the reduction in the forces acting transversely to the direction of movement the traction means is guided in a more gentle manner at the roller than if no coating were present. The reduction is greater the lower the coefficient of friction for contact between the friction means and the coating.

The coefficient of friction for contact between the traction means and the coating is preferably dimensioned in such a manner that in the case of movement of the traction means relative to the roller there is no generation of a torsional moment of the traction means about the longitudinal direction thereof which exceeds a predetermined limit value critical for damage of the traction means. This criterion is usable particularly in cases in which cables with a round cross-section are employed as traction means. Cables with a round cross-section can, due their shape, twist particularly readily about the longitudinal direction thereof and can thus be damaged. A cable with a round cross-section is not usually guided at a roller with a mechanically positive couple. If a cable with a round cross-section is guided at the surface of a roller, for example in a groove, with a diagonal tension then the cable can roll at the surface of the roller transversely to the longitudinal direction of the cable, i.e. execute a rotational movement about the longitudinal direction. Usually further devices are present in the elevator installation to limit the freedom of movement of the cable in the vicinity of the roller, for example cable fixing points or further guide elements which keep the movement of the cable in predetermined paths. Since the cable consequently has to satisfy predetermined boundary conditions in the case of a movement in its longitudinal direction, the mentioned rotational movement of the surface of the roller leads to a torsion of the cable about its longitudinal direction. The torsion of the cable can, under diagonal tension, constantly increase in the case of movement of the cable in its longitudinal direction insofar as the cable can roll at the surface of the roller transversely to its longitudinal direction. If the roller is coated in accordance with the present invention and the cable brought into contact with the coating, then a torsion of that kind can be prevented or at least restricted to a maximum value, which is lower the smaller the coefficient of friction for the contact between the cable and the roller. A low friction between the cable and the roller improves the possibility of the cable sliding, instead of rolling, under diagonal tension transversely to the longitudinal direction of the cable. This limits the torsion of the cable and counteracts damage of the cable due to excessive torsion.

In this manner it is achieved that no torsional moment or a comparatively low torsional moment—referred to the longitudinal direction of the traction means—acts on the traction means when the traction means runs obliquely over the roller and is then brought into contact with the coating. This configuration is particularly advantageous in the case of use of cables which have a high degree of sensitivity relative to diagonal tension and accordingly cannot be loaded by large torsional moments with respect to their length direction.

The coefficient of friction for contact between the traction means and the coating is preferably dimensioned to be small in such a manner that in the case of movement of the traction means relative to the roller there is no generation of deformation of the traction means, transversely to the direction of movement thereof, which exceeds a predetermined limit value critical for damage of the traction means. A lower coefficient of friction for contact between the friction means and the coating gives the precondition for the fact that in the case of contact between the roller and the traction means particularly low forces can act on the traction means transversely to the direction of movement thereof. Deformations of the traction means transversely to the direction of movement thereof are thereby limited. This has a particularly gentle effect on the traction means if the roller has a groove in order to laterally guide the traction means. If in this case the forces which act transversely to the direction of movement of the traction means are reduced by an appropriate coating according to the invention then also the pressing forces rising on contact between the flank of the groove and the traction means are reduced. Wear phenomena traceable to an interaction between a groove flank and the traction means are thereby reduced or even avoided. The mechanical interaction between the groove flank and the traction means can, in itself, be reduced if the groove flank is provided with a friction-reducing coating. This criterion is, inter alia, also usable in cases in which belts or twin cables are employed as traction means.

Belts or twin cables usually do not have a round cross-section and accordingly can be guided with a mechanically positive couple in a groove, which is formed at the surface of a roller, during circulation around the roller, for example when the shape of the groove at the base of the groove is adapted to the shape of the cross-section of the belt or the twin cable. If a traction means, for example a belt or a twin cable, is guided with mechanically positive couple in a groove at the surface of a roller under diagonal tension then the traction means cannot roll at the surface of the roller transversely to the longitudinal direction of the traction means without restriction. Under this precondition the traction means under diagonal tension is less loaded by torsion. Rather, the traction means under diagonal tension is constrained to slide at flanks of the groove transversely to the longitudinal direction of the traction means. In that case the traction means can be deformed. The regions of the traction means which are brought into contact with the flanks of the groove are, in particular, mechanically loaded and in a given case worn. A friction-reducing coating of the groove flanks according to the present invention produces a loading of that kind and diminishes or prevents wear of the traction means.

The concept stated in the foregoing can be translated particularly advantageously in the case of deflecting rollers for the traction means. In the case of a deflecting roller there is no necessity to transmit large traction forces between the roller and the traction means. The coefficient of friction for contact between the traction means and the roller can accordingly be selected to be as small as possible. One form of embodiment of the device according to the present invention accordingly comprises one or more deflecting rollers for the traction means, wherein the deflecting roller has a coating according to the invention at all regions of the roller with which the traction means stands in contact or can be brought into contact in operation. Such a deflecting roller allows particularly gentle guidance of the traction means. This applies not only to cables, but also to belts. This applies particularly to traction means guided in a groove at the roller surface. Moreover, the coating stabilizes the lateral guidance of the traction means. For example, wandering of the traction means out of the groove can be avoided. This is particularly relevant for the guidance of belts which run in a groove at the surface of a roller.

According to the present invention it is not in principle necessary to arrange a friction-reducing coating at all regions of a roller at which the traction means is brought into contact with the roller in operation. Depending on the respective use it can be advantageous to cover only partial regions of the roller body with a friction-reducing coating in the sense of the invention. Depending on its instantaneous arrangement the traction means can in a given case be brought into contact with the coating or with the roller body. Alternatively, also a part section (or several part sections) of the traction means can be brought into contact with the roller body and another part section (or several other part sections) brought into contact with the coating. In this manner it is possible to selectively vary the friction between the traction means and the roller depending on the relative arrangement of the traction means and the roller.

In the case of a roller which has a groove for guidance of the traction means a friction-reducing coating according to the invention can, for example, be arranged merely at the flanks of a groove formed in a roller body. In this case, the coefficient of friction for contact between the traction means and the roller is at a maximum if the traction means is brought into contact exclusively with the roller body at the base of the groove. Conversely, the coefficient of friction for contact between the traction means and the roller is reduced if at least partial sections of the traction means—instead of standing in contact with the roller body—are brought into contact with the friction-reducing coating at the groove flank. This concept of “selective coating” is usable with advantage particularly with respect to the construction of drive rollers. On this basis it is possible to construct drive rollers by which on the one hand large traction forces can be transmitted to a traction means, but which on the other hand do not transmit torsional moments, or transmit only small torsional moments, to the traction means when the traction means runs obliquely over the roller. This concept is usable particularly advantageously with traction means which have a high degree of sensitivity relative to twistings about the longitudinal direction thereof.

Coatings according to the present invention can be realized in different ways. Coatings which on the one hand can be applied to a suitable carrier and moreover ensure a coefficient of friction for contact between a traction means and the coating which is lower than the corresponding coefficient of friction for contact between the traction means and the carrier can comprise, for example, lubricant. Usable as lubricant are, for example, different dry lubricants or different wet lubricants or also mixtures of these lubricants. These lubricants can also be embedded in suitable binders. In the latter case, lubricant and binder can be so selected in targeted manner that the binder ensures a sufficient stability of the coating, whilst the lubricant can be so selected that the coefficient of friction for contact between the coating and the traction means is particularly low.

The present invention brings significant advantages in the case of traction means with load-bearing elements, which have a sheathing of an elastomer, for example polyurethane or rubber. Sheathings of that kind are on the one hand economically producible, for example by extruding in the case of polyurethane or by vulcanization in the case or rubber. Traction means with the sheathing of that kind have, however, an extremely high coefficient of friction for contact with materials from which conventional rollers for traction means for elevators are made, for example steel, cast iron, polytetrafluoroethylene (PTFE or “Teflon”) or the like. A traction means with a casing of polyurethane or rubber can have, for example, a coefficient of friction in the region of 0.4 to 0.9 for contact with a roller of steel, cast iron, polytetrafluoroethylene (PTFE or “Teflon”). If the roller is provided with a coating according to the invention, then the corresponding coefficient of friction can be reduced to less than 0.2. This can be achieved with, for example, a coating on the basis of polytetrafluoroethylene (PTFE or “Teflon”). A reduction of that kind in the coefficient of friction significantly reduces the effect of diagonal tension on the traction means. This is particularly useful in the case of traction means which are particularly sensitive with respect to diagonal tension and can be particularly easily damaged under diagonal tension, for example traction means with load-bearing elements of synthetic fibers such as, for example, aramide.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic view of an elevator installation for transporting an elevator car and a counterweight by means of a movable traction means, with a drive roller and several deflecting rollers for the traction means;

FIG. 2A is a view in the direction of an arrow 2A in FIG. 1, of the drive roller with the cable as traction means, wherein the cable runs obliquely over the drive roller;

FIG. 2B is view in the direction of arrows 2B in FIG. 2A;

FIG. 3 is a longitudinal section through a roller with a coating according to the present invention and the cable running around the roller;

FIG. 4 is a longitudinal section through a roller, similar to FIG. 3, but with an alternative arrangement of the coating according to the present invention;

FIG. 5 is a longitudinal section through a roller with a coating according a third embodiment of the present invention and a belt running around the roller;

FIG. 6 is a longitudinal section through a roller with a coating according to a fourth embodiment of the present invention and a belt running around the roller; and

FIG. 7 is a longitudinal section through a roller with a coating according to a fifth embodiment of the present invention and a belt running around the roller.

### DESCRIPTION OF THE PREFERRED EMBODIMENT

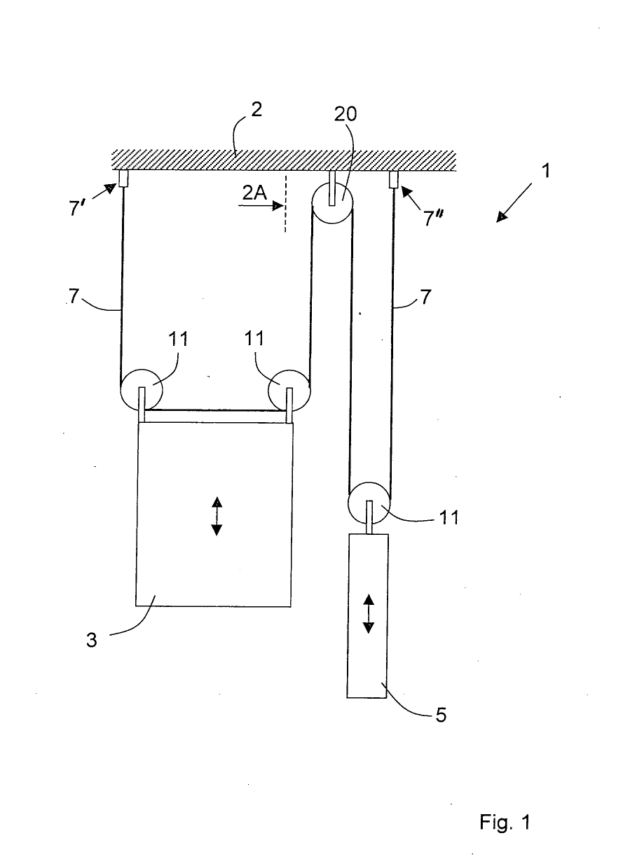

FIG. 1 shows—as an example for a device for transporting at least one load by at least one movable traction means connected with the load—an elevator 1. The elevator 1 comprises two loads transportable by a traction means 7: an elevator car 3 and a counterweight 5. Two ends 7′, 7″ of the traction means 7 are fastened to a roof construction 2. The traction means 7 is guided at a rotatably mounted drive roller 20, which is arranged—together with a drive (not illustrated) for the drive roller 20—at the roof construction 2. In the present case a respective length section of the traction means 7 is defined between the drive roller 20 and each of the two ends 7′, 7″ of the traction means 7, wherein one of the two length sections is connected with the elevator car 3 and the other of these lengths sections with the counterweight 5. In that case the elevator car 3 is connected with the traction means 7 by means of two deflecting rollers 11, which are rotatably arranged at the elevator car 3, to form a so-termed 2:1 suspension, whilst the counterweight 5 is connected with another deflecting roller 11, which is rotatably arranged at the counterweight 5, to similarly form a 2:1 suspension. The traction means 7 is brought into contact with the drive roller 20 and the deflecting rollers 11 in such a manner that different sections of the traction means respectively loop around a part of the drive roller 20 and respective parts of the deflecting rollers 11. Inasmuch as the drive roller 20 is set into rotation about its axis of rotation, traction forces are transmissible to the traction means 7 and the traction means 7 is movable in its longitudinal direction in such a manner that the lengths of the length sections of the traction means 7, which are formed at both sides of the drive roller 7, are variable. Since the elevator car 3 and the counterweight 5 are suspended at the traction means 7 by means of the deflecting rollers 11, a rotation of the drive roller 20 has the effect that the elevator car 3 and the counterweight 7 are moved in opposite sense—depending on the respective direction of rotation of the drive roller 20—upwardly and downwardly, as is indicated in FIG. 1 by double arrows.

The traction means 7 is guided by the drive roller 20 and the deflecting rollers 11 during movement. The traction means 7 can be realized as, for example, a cable or a belt. Alternatively, the elevator car 3 and the counterweight 5 can also be suspended at several traction means 7 which are each guided over the drive roller 20 and the deflecting rollers 11.

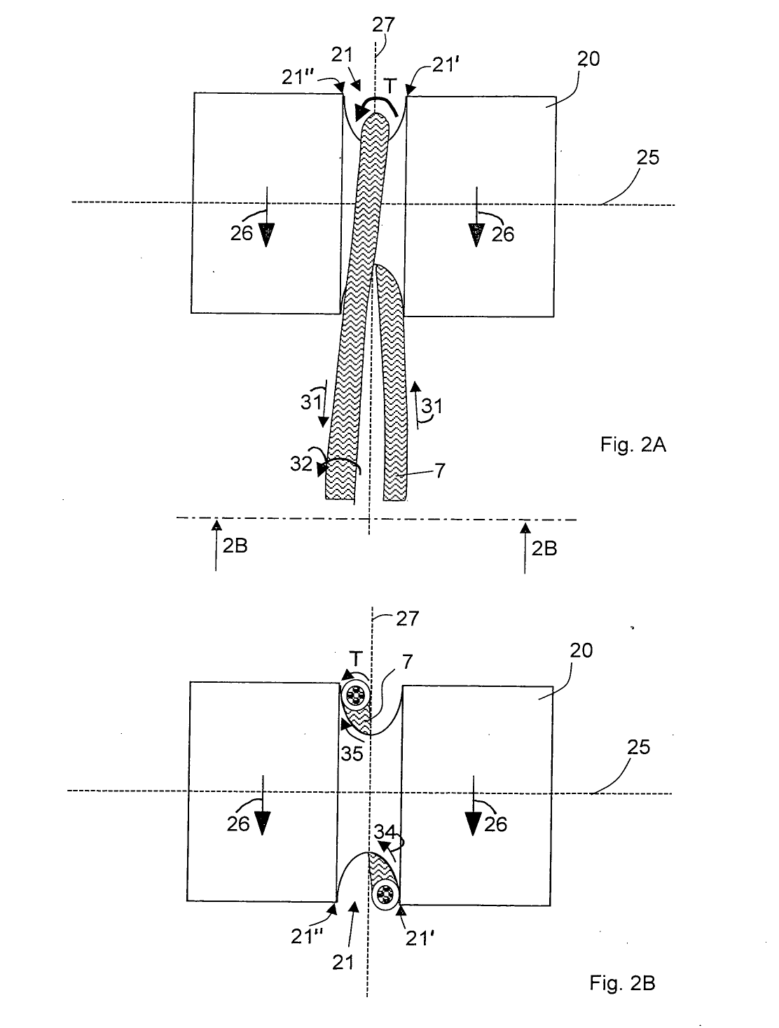

The course of the traction means 7 in the vicinity of the drive roller 20 is illustrated in detail in FIGS. 2A and 2B. FIG. 2A in that case shows a view in the direction of the arrow 2A in FIG. 1, i.e. in horizontal direction, whereas FIG. 2B shows a view in the direction of the arrows 2B in FIG. 2A, i.e. in vertical direction from the bottom to the top. It is assumed that the traction means 7 is constructed as a cable with round cross-section and that the drive roller 20 has a groove 21 at its surface. The groove 21 is arranged symmetrically with respect to a plane 27 aligned vertically to an axis 25 of rotation of the drive roller 20. The position of the base of the groove 21 is defined by the section line between the plane 27 and the drive roller 20.

FIGS. 2A and 2B illustrate the drive roller 20 in a state of rotation about the axis 25. Arrows 26 indicate the direction of movement of the respective surface, which faces the observer, of the drive roller 20. In addition, it is assumed that the traction means 7 is guided by the groove 21. Due to the rotation of the drive roller 20, the traction means 7 is moved in its longitudinal direction, i.e. in the direction of arrows 31, and guided along the surface of the drive roller 20 by the groove 21. Moreover, it is assumed that the traction means 7—due to the relative arrangement of the drive roller 20 or the groove 21 with respect to the deflecting rollers 11 at the elevator car 3 and the counterweight 5—is not guided exactly parallel to the plane 27. Under this precondition the traction means 7—influenced by the tension forces acting on the traction means 7—stands in contact with the drive roller 20 along a curve which runs obliquely with respect to the plane 27. In other words, in the present configuration the traction means 7 is disposed under diagonal tension. In the situation illustrated in FIGS. 2A and 2B the traction means 7 runs at the uppermost point of its path at the base of the groove, i.e. in the center between the boundary flanks of the groove, and there intersects the plane 27 (see FIG. 2A). As can be further inferred from FIGS. 2A and 2B, the section of the traction means 7 running in a direction towards the roof construction 2 (upwardly) impinges at an edge 21′ of the groove 21 on the surface of the drive roller 20 and approaches the plane 27 on one flank of the groove 21, as is indicated by an arrow 34. The section of the traction means 7 running away from the roof construction 2 (downwardly) departs from the plane 27 and approaches the other flank of the groove 21 at another edge 21″ of the groove 21, as is indicated by an arrow 35.

In the case of the circulation around the drive roller illustrated in FIGS. 2A and 2B the traction means 7 can, in certain circumstances be deformed in that the traction means 7 during running around the drive roller 20 executes not only a movement in the direction of its length, but due to the guidance of the traction means 7 necessarily also a movement in direction of the axis 25 of rotation, i.e. transversely to the direction of the length of the traction means 7. Whether or how the traction means 7 is, in a given case, deformed depends, apart from specific properties of the traction means 7 itself, for example the shape and the resilient characteristics of the traction means 7, particularly on the friction between the traction means 7 and the surface with which the traction means 7 stands in contact. If, for example, this friction is small, then the traction means 7 during its movement in the direction of the axis 25 of rotation can slide without the traction means 7 being significantly deformed transversely to its length. If the friction is extremely high, then the traction means 7 can adhere along a section to the surface of the drive roller 20 and react to the diagonal tension, which is present, by a deformation transversely to the length of the traction means. This deformation is usually limited in that excessive resilient stresses in the traction means 7 can be reduced by movements of part sections of the traction means 7 relative to the surface of the drive roller 20, for example by sliding movements of the respective part sections or also rotational movements of these part sections about the respective longitudinal direction thereof.

In the example according to FIGS. 2A and 2B it is assumed that the coefficient of friction for contact between the traction means 7 and the drive roller 20 is of such a size that the traction means 7 cannot slide without resistance in the direction of the axis 25 of rotation or in the direction of the arrows 34 and 35. This assumption is compatible with the requirement that large traction forces have to be transmitted by the drive roller 20—in correspondence with its function in the elevator 1—to the traction means 7. In the present case the movement of the traction means 7 longitudinally of the arrows 34 and 35—depending on the respective size of the coefficient of friction for contact between the traction means 7 and the drive roller 20—is connected with a rolling movement or a superimposition of a rolling movement and a sliding movement. The rolling movement is promoted in the present case by the round shape of the cross-section of the friction means 7. Moreover, the rolling movement is promoted by the fact that the traction means 7 is guided at the base of the groove 21 without a mechanically positive couple. Due to the rolling movement, the traction means 7 is rotated about its longitudinal direction. The direction of the rotation is indicated in FIG. 2A by an arrow 32.

In the present case a rotation of the traction means 7, which is produced at the drive roller 20 during rotation of the drive roller 20, does not extend uniformly over the entire length of the traction means 7. The traction means 7 is, in particular, not freely rotatable over the entire length, because of rotation of the traction means 7 about the longitudinal axis thereof is restricted or prevented at several places, for example at the ends 7′, 7″ of the traction means 7 due to fastening of the traction means 7 to the roof construction 2 or to the deflecting rollers 11, by reason of friction between the traction ends 7 and the deflecting rollers 11. Consequently, rotation of the drive roller 20 causes torsion of the traction means about the longitudinal direction thereof.

In the case of the situation illustrated in FIGS. 2A and 2B, rotation of the traction means 7 in the direction of the arrow 32 is characterized by a torsional moment T, the direction of which is indicated in each of FIGS. 2A and 2B by arrows.

In the case of FIGS. 2A and 2B the effect of a diagonal tension on the traction means 7 is illustrated by way of example on the basis of the drive roller 20. It may be noted that the illustrated technical interrelationships are translatable in an analogous manner to the movement of the traction means 7 at the deflecting rollers 11. In addition, it may be noted that the presence of the groove 21 is not an essential precondition for the occurrence of the twisting 32. A sufficient condition for occurrence of twisting of the traction means 7 is the presence of diagonal tension. In general, the traction means 7 is disposed under diagonal tension when the traction means 7 is guided in the elevator 1 in such a manner that the traction means on movement in the longitudinal direction thereof in contact with the rollers 11 and 20 is moved at least in sections in the direction of one of the axes of rotation of the rollers 11 and 20.

The torsion of the traction means 7 due to the interaction of the traction means 7 with the rollers 11 and 20 quantitatively depends on several factors a) to c):

a) on the respective coefficients of friction for the contacts of the tension means 7 with the rollers 11 and 20;

b) on the torsional stiffness of the traction means 7; and

c) on the “extent” of the diagonal tension at each individual roller, for example characterized by the angle between the axis of rotation of the respective roller in the course of the longitudinal direction of the traction means 7 along the surface of the roller (if this angle is equal to 90° at all points at which the traction means 7 is brought into contact with the roller, then no diagonal tension is present, i.e. the traction means 7 moves at the surface of the roller within a plane perpendicular to the axis of rotation of the roller; the greater the departure of this angle from 90° at a selected length section of the traction means 7 at the surface of the roller, the more strongly imposed is the diagonal tension).

The above factor b) is frequently established by requirements which are oriented to the traction means itself (for example, with respect to the choice of material, the construction, the mechanical and thermal characteristics, etc.). The above factor c) is frequently established by parameters which concern the design of the elevator 1 (for example, by the physical arrangement of the components of the elevator, which serve for guidance of the traction means 7, and by the accuracy with which these components are made and/or installed).

The present invention concerns the above factor a); according to present invention, rollers with which a traction means is brought into contact in order to guide the traction means can be provided with a friction-reducing coating. Applied to the examples according to FIGS. 1, 2A and 2B, the present invention makes it possible to reduce the coefficients of friction for contact of the traction means 7 with the rollers 11 and 20. It is thereby possible to reduce or to minimize torsional moments caused by diagonal tension. In the best case, torsion of the traction means can be avoided.

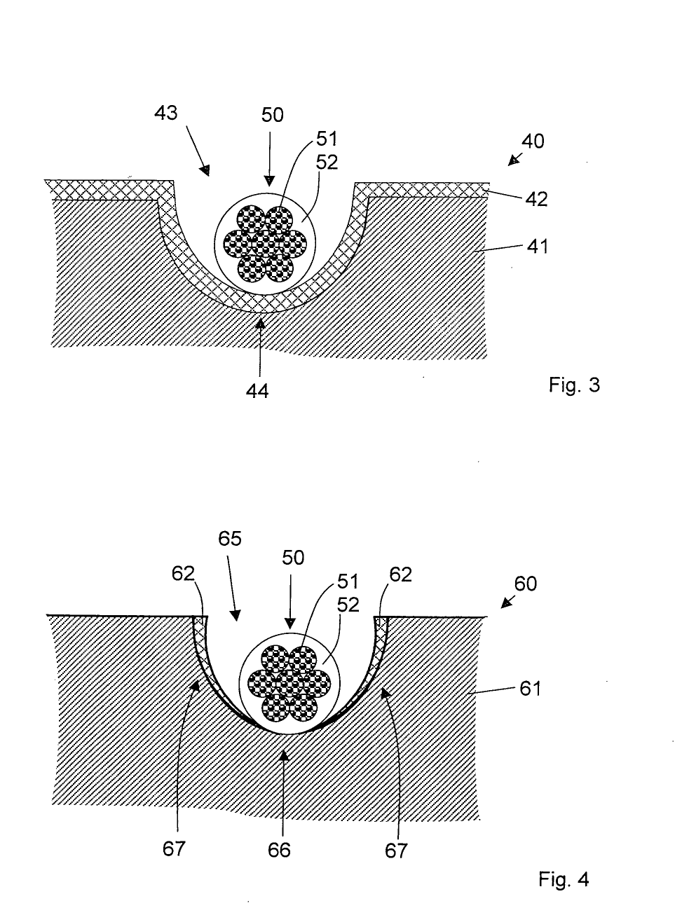

FIGS. 3 and 4 show examples of rollers which have a coating according to the invention, in each instance together with a traction means 50 which is guided at a surface of the respective roller. The illustrated rollers are suitable for use in the elevator 1 as a substitute for the rollers 11 and 20, respectively.

The traction means 50 in the present examples is a cable with round cross-section. It comprises several load-bearing elements 51 which are twisted together and are surrounded by a sheathing in the form of a casing 52. The load-bearing elements 51 can be realized in different ways. The load-bearing elements 51 can contain, for example, natural fibers and/or fibers of a synthetic material, for example of aramide, and/or at least one metallic wire. The casing 52 can be formed from, for example, an elastomer such as polyurethane or natural or synthetic rubber (EPR) or silicone rubber. However, it may be noted that the structure, which is shown here, of the traction means 50 does not represent a restriction for execution of the present invention. The traction means 50 could also be replaced by other kinds of cables or by belts.

FIG. 3 shows a longitudinal section of a roller 40 along the axis of rotation (not illustrated) of this roller together with a cross-section through the traction means 50. The roller 40 comprises a roller body 41 which serves as carrier for a coating 42. The coating 42 forms a surface of the roller 40. A groove 43 is formed at the surface of the roller 40. The groove 43 runs along a plane arranged perpendicularly to the axis of rotation of the roller 40 and has a semi-circular cross-section radiused at a base 44 of the groove. In the present case the coating 42 forms a closed covering of the roller body 41 in the region of the groove 43, i.e. the surface of the roller 40 is formed by the coating 42 not only at the base 44 of the groove 43, but also at the flanks of the groove 43. In FIG. 3 the traction means 50 is guided by the groove 43. In the present case the traction means 50 in the groove 43 can be brought exclusively into contact with the coating 42. Contact with the roller body 41 is not possible.

FIG. 4 shows a longitudinal section of a roller 60 along the axis of rotation (not illustrated) of this roller together with a cross-section through the traction means 50. The roller 60 comprises a roller body 61 which serves as carrier for a coating 62. A groove 65 is formed at the surface of the roller 60. The groove 65 runs along a plane arranged perpendicularly to the axis of rotation of the roller 60 and has a semi-circular cross-section radiused at the base 66 of the groove. The coating 62 forms a surface of the roller 60 at flanks 67 of the groove 65. The surface of the roller 60 is formed, at the base 66 of the groove 65, by the roller body 61. In FIG. 4 the traction means 50 is guided by the groove 65. In the present case the traction means 50 can be brought, at the base 66, into contact with the roller body 62 and, at the flanks 67, into contact with the coating 62.

The roller bodies 41 and 61 can be made of, for example, steel, cast iron, polyamide, Teflon, aluminum, magnesium, non-ferrous metals, polypropylene, polyethylene, polyvinylchloride, polyamide, polyetherimide, ethylenepropylenediene monomer (EPDM) or polyetheretherketone (PEEK). These materials are, by virtue of their strength, suitable as materials for rollers provided for use in elevator installations or other devices for transporting loads.

The coating 42 or the coating 62 shall, according to the present invention, fulfill the criterion that a coefficient of friction for contact between the traction means 50 and the coating 42 or the coating 62 is less than the corresponding coefficient of friction for contact between the traction means 50 and the roller body 51 or the roller body 61.

The criterion stated in the foregoing can be fulfilled in different ways. The coating 42 or the coating 62 can be formed from a suitable lubricant or can contain such a lubricant as a component. In the present case, various dry lubricants, wet lubricants or mixtures of these lubricants are suitable as the lubricant. The coatings 42 and 62 can be formed from, for example, dry lubricants such as talcum, graphite powder, molybdenum disulfide, polytetrafluoroethylene (PTFE), lead (Pb), gold (Au), silver (Ag), boron trioxide (BO₃), lead oxide (PbO), zinc oxide (ZnO), copper oxide (Cu₂O) molybdenum trioxide (MoO₃), titanium dioxide (TiO₂) or mixtures of these substances. These materials can be applied to the roller bodies 41 and 61, respectively, by known methods, for example by sputtering, vapor deposition, mechanical pressing methods or chemical methods.

The coatings 42 and 62 can also be formed from wet lubricants such as, for example, animal, plant, petrochemical and/or synthetic oil or grease, glycerol, polybutene, polymer esters, polyolefines, polyglycols, silicone, soap, natural or synthetic wax, resin and/or tars with additives of organic or inorganic thickeners, for example organic polymers, polycarbamide, metal soaps, silicates, metal oxides, silicic acid, organophilic bentonites or mixtures of these substances. It is also possible to mix dry lubricants in the form of particles and/or wet lubricants with hardenable binders and to form the coatings 42 and 62 from such mixtures. In the latter case the durability of the coating can be optimized by a suitable choice of the respective binder, whilst the desired friction-reducing effect can be produced in selective manner by a suitable choice of the respective lubricant. Various known substances are suitable as binder, for example lacquer on the basis of synthetic resin, acryl, polyester, vinylester, polyurethane, epoxide or the like.

The traction means 50 has—furnished with a casing of polyurethane or rubber—a coefficient of friction in the region of 0.4 to 0.9 for contact with a roller body of usual materials such as steel, cast iron, polytetrafluoroethylene (PTFE or “Teflon”). If the surface of the roller is provided with a coating according to the present invention, then the corresponding coefficient of friction for contact between the traction means 50 and the roller can be reduced to less than 0.2. For example, a reduction in the coefficient of friction to 0.19 can be achieved by a coating with a dry lubricant on the basis of polytetrafluoroethylene particles and a suitable binder, for example with a layer thickness in the region between 0.01 millimeters and 1 millimeter. This also applies to a roller body which is itself made from polytetrafluoroethylene. The extent of reduction in the coefficient of friction can vary, for example in dependence on material parameters of the polytetrafluoroethylene particles which are influenced by the mode and manner of production of the particles (size of the particles, length of the polymer chain, etc.).

In the case of the roller 40 (FIG. 3), the coating 42 effects a reduction in the coefficient of friction for contact between the traction means 50 and the roller 40 at all places at which the traction means in the groove 43 can be brought into contact with the roller 50 by comparison with a corresponding contact of the traction means 50 with the uncoated roller body 41. The coating 42 improves the ability of the traction means 50 to slide within the groove 43 in the transverse direction of the groove 43. The risk is thereby reduced that the traction means in the case of diagonal tension rolls along through the groove 43 of the flanks of the groove 43 instead of sliding. Accordingly, the risk that the traction means 50 is deformed by a torsion in the case of diagonal tension at the roller 40 is also reduced. A torsion of the traction means 50 can also be avoided under the precondition of the coefficient of friction for contact between the friction means 50 and the roller 40 being sufficiently small. The coating 42, however, also produces a reduction in the traction forces between the traction means 50 and the roller 40 when the traction means is guided through the groove 43. The roller 40 is accordingly preferably usable as a deflecting roller.

In the case of the roller 60 the coefficient of friction for contact between the traction means 50 and the roller 60 within the groove 65 varies in the transverse direction of the groove 65. The coefficient of friction is at a maximum when the traction means 50 is brought into contact with the roller body 61 at the base 66 of the groove 65. The coating 62 improves the capability of the traction means 50 within the groove 65 of sliding in the transverse direction of the groove 65. The risk of the traction means rolling, instead of sliding, through the groove 65 at the flanks 67 of the groove 65 in the case of diagonal tension is thereby reduced. Accordingly, the risk that the traction means 50 is deformed by a torsion in the case of diagonal tension at the roller 60 is also reduced. A torsion of the traction means 50 can also be avoided if, for example, the coefficient of friction for contact between the traction means 50 and the roller 60 is of such a small size that the traction means 50 exclusively slides at the flanks 67. Since the coefficient of friction for the contact between the traction means 50 and the roller 60 corresponds with the coefficient of friction for contact between the traction means 50 and the roller body 61 when the traction means 50 is guided along the base 66 of the groove 65 it is possible to transmit, by the roller 60, large traction forces between the roller 60 and the traction means 50. The roller 60 is accordingly usable not only as a deflecting roller, but also as a drive roller.

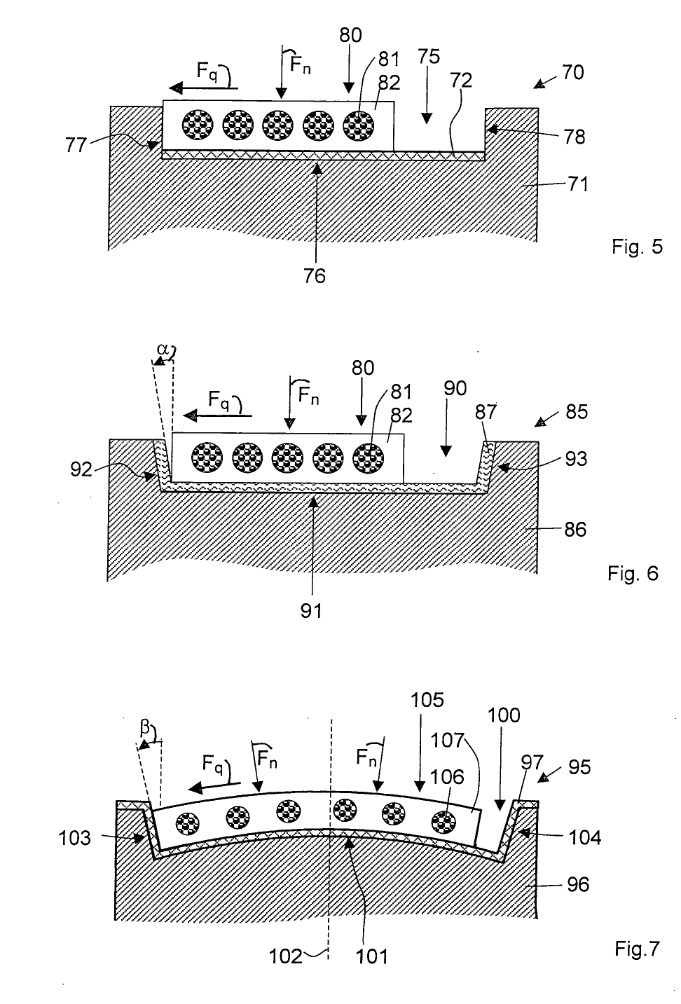

FIGS. 5 to 7 show different rollers 70, 85 and 95 which are specially constructed for guidance of traction means in the form of belts and accordingly each have a form adapted to the external shape of belts. The rollers respectively have coatings according to the present invention. In the following, the effect of these coatings on different belts, which stand in contact with these coatings and are guided at the surfaces of the respective rollers, is discussed.

FIGS. 5 to 7 illustrate—each time in cross-section—belts 80 and 105 when running around one of the rollers 70, 85 and 95. Each of the rollers 70, 85 and 95 is in that case shown in a longitudinal section along its axis of rotation (not illustrated in each instance). It is assumed in each instance that the respective rollers and belts are components of a device according to the invention for transporting a load with the help of the stated belts, wherein the remaining components of this device are not, however, illustrated.

The belts 80 and 105, respectively, differ from the traction means 50 substantially by the shape of a cross-section: by contrast to the traction means 50, the belts 80 and 105 have a rectangular cross-section. The belts 80 and 105 are each guided in such a manner that the wide sides thereof rest on the respective rollers.

The belts 80 have several load-bearing elements 81 extending in the longitudinal direction thereof and a casing 82 surrounding the load-bearing elements 81. The belt 105 has a similar construction: it comprises several load-bearing elements 106 extending in the longitudinal direction thereof and a casing 107 enclosing the load-bearing elements 106. With respect to materials, the belts 80 and 105 do not have any exceptional features by comparison with the traction means 50: the considerations indicated for the load-bearing elements 51 accordingly apply to the load-bearing elements 81 and 106 and the specifications stipulated for the casing 52 are accordingly usable for the casings 82 and 107.

The rollers 70, 85 and 95 respectively have at the surfaces thereof a groove 75, 90 or 100 for guidance of one of the belts 80 and 105. The grooves 75, 90 and 100 differ substantially by their shape (in a planar section along the axis of rotation of the respective roller) and by different arrangements of coatings 72, 87 and 97 according to the invention.

According to FIG. 5 the roller 70 comprises a roller body 71 and the coating 72. The groove 75, which is formed at the surface of the roller 70, has a base 76 which does not have any curvature in the direction of the axis of rotation of the roller 70 and accordingly is represented in FIG. 5 by a straight line. The groove 75 has flanks 77 and 78 which are formed perpendicularly to the axis of rotation of the roller 70. The coating 70 covers the roller body 71 exclusively at the base 76 of the groove 75. The belt 80 is guided in the groove 75 in such a manner that one of its wide sides rests on the base 76 of the groove. The belt 80 can accordingly be brought into contact exclusively with the coating 72, at the flanks 77 and 78, as opposed to with the roller body 71.

According to FIG. 6 the roller 85 comprises a roller body 86 and the coating 87. The groove 90, which is formed at the surface of the roller 85 has a base 91 which does not have any curvature in the direction of the axis of rotation of the roller 85 and accordingly is represented in FIG. 6 by a straight line. The groove 90 has flanks 92 and 93, which have the form of a frustum and are illustrated in FIG. 6 by lines which have an angle α of inclination with respect to a plane oriented perpendicularly to the axis of rotation of the roller 85. The coating 87 covers the roller body 86 at the base 91 and the flanks 92 and 93 of the groove 90. The belt 80 is guided in the groove 90 in such a manner that one of its wide sides rests on the base 91 of the groove. The belt 80 can accordingly be brought into contact at the base 91 and the flanks 92 and 93 of the groove 90 exclusively with the coating 87, but not with the roller body 86.

According to FIG. 7 the roller 95 comprises a roller body 96 and the coating 97. The groove 100, which is formed at the surface of the roller 95, has a base 101 which—considered in a section in a plane along the axis of rotation of the roller 95—is represented by a convexly curved line. Since the base 101 is curved in the direction of the axis of rotation of the roller 95, cross-sections of the roller 95 perpendicular to the axis of rotation of the roller 95 have circumferential lines of different length in the region of the base 101. The position of the cross-section with the longest circumferential line within the groove 100 is marked by a line 102 in FIG. 7. The groove 100 has flanks 103 and 104 which have the form of a frustum and are illustrated in FIG. 7 by lines which have an angle β of inclination with respect to a plane oriented perpendicularly to the axis of rotation of the roller 95. The coating 97 covers the roller body 96 at the base 101 and at the flanks 103 and 104 of the groove 100 and additionally outside the groove 100. The belt 105 is guided in the groove 100 in such a manner that one of its wide sides rests on the base 101 of the groove. The belt 105 accordingly can be brought into contact at the base 101 and at the flanks 103 and 104 of the groove 100 and in the immediate vicinity of the groove 100 exclusively with the coating 97, but not with the roller body 96.

With respect to the materials from which the roller bodies 71, 86 and 96 can be made, the considerations are applicable which are indicated with respect to the roller bodies 41 and 61. With respect to the materials for the coatings 72, 87 and 97, the specifications which are indicated for the coatings 42 and 62 are usable in analogous manner.

The width of the grooves 75 and 80 (measured in the direction of the axes of rotation of the rollers 70 and 85) is selected to be greater in each instance than the width of the belt 80. Correspondingly, the width of the groove 100 (measured in the direction of the axis of rotation of the roller 95) is selected to be greater than the width of the belt 105.

Due to the fact that the belts 80 and 105 are guided each time in grooves which are wider than the respective belts, the freedom of movement transversely to the respective groove is given for the belt 80 in the grooves 75 and 90 and for the belt 105 in the groove 100. This freedom of movement is desired for several reasons. On the one hand, in this way a certain (desired) tolerance particularly with respect to the accuracy of the positioning of the rollers is guaranteed during installation of the rollers, which simplifies installation. In addition, it is to be taken into consideration that the belts 80 and 105—as generally usual with belts—are not homogenous as a consequence of the properties of the materials used and the characteristics of the method for production of the belts: the mechanical properties of a belt usually vary within the scope of certain tolerances not only in longitudinal direction, but also in transverse direction of the belt. As a consequence of such inhomogenieties, each belt when running round a roller under tension in the longitudinal direction of the belt has a tendency to execute movements in the transverse direction of the belt on the surface of the roller. These transverse movements go along with compensation of the resilient stresses which arise in the belt, when running around the roller, under the action of the tension. The transverse movements of the belt at the surface of the roller are in that case to be set in relation with the transverse force F_{q} which acts transversely to the longitudinal direction of the belt and can vary in dependence on the instantaneous resilient stresses in the belt. If the belt were guided by a groove in contact at the two flanks thereof respectively with the narrow sides of the belt, then on the one hand the transverse movements of the belt would be suppressed, but on the other hand the belt would interact with the flanks of the groove under the action of the transverse force F_{q}. This interaction promotes wear of the belt. Moreover, the belt, when it is pressed against a flank of the groove under the action of transverse force F_{q}, can be resiliently deformed in the transverse direction. In certain circumstances the belt can, under the action of transverse force F_{q}, be obliged to migrate over the flanks of the groove in order to compensate for resilient stresses. This can, in the case of operation of the device, lead to an unforeseen interruption of operation.

In order to minimize wear of a belt it is accordingly desirable to select the spacings of the flanks of the grooves 75 and 90 or of the groove 100 to be greater than the width of the belt 80 or of the belt 105. Due to the fact that the belts can, during running around the respective rollers, execute movements in their transverse direction within the scope of specific tolerances, the narrow sides of the belt are not constantly in contact with one of the flanks of the grooves. Moreover, a movement of the belt in its transverse direction is usually connected with a reduction in the transverse force F_{q}. In this way wear of the belt is reduced.

Since the belts 80 and 105 can execute transverse movements in the grooves 72, 90 and 100 it is possible that the belt during running around the rollers 70, 85 and 90 adopts positions in which it is disposed under a diagonal tension.

The invention opens up a possibility of minimizing the transverse forces F_{q} acting on one of the belts 80 or 105 during running around one of the rollers 70, 85 or 95 and thus of guiding the belts 80 and 105 particularly gently and securely. It has proved that the transverse force F_{q} acting on one of the belts when running around one of the rollers is higher the greater the friction between the belt and the respective roller. The friction is proportional to the respective normal force Fₙ which acts on belts perpendicularly on the surface of the respective roller and to the coefficient of friction for contact between the belt and the respective roller.

In the examples according to FIGS. 5 to 7 the normal force Fₙ between the belt 80 and the rollers 70 and 85 and between the belt 105 and the roller 95 is predetermined each time by the respective tension forces acting on the belt and the physical arrangement of the belt and the rollers. According to the present invention the respective transverse force F_{q} acting on the belts 80 and 105 is minimized in that the coefficient of friction for contact between the belts 80 and 105 and one of the coatings 72, 87 and 97 is less than the corresponding coefficient of friction for contact between the belts 80 and 105 and the roller body 71, 86, 96. Since the belt 80 when running around the rollers 70 and 85 is always brought into contact with the coatings 76 and 87 the transverse force F_{q}, which acts on the belt 80 in the grooves 75 and 80 is fundamentally reduced by comparison with the case of the rollers 70 and 85 not having the coatings 76 and 87. Since the belt 105 when running around the roller 95 is always brought into contact with the coating 97 the transverse force F_{q}, which acts on the belt 105, in the groove 100 is fundamentally reduced by comparison with the case of the roller 95 not having the coating 97.

The grooves 75, 90, 100 differ with respect to the shape thereof and the respective arrangement of the coatings 72, 87 and 97 according to the invention. The grooves 75, 90 and 100 accordingly have a different influence on guidance of the belt 80 or 105.

In the following it is assumed (for the sake of example) that the coatings 72, 87 and 97 in the situations illustrated in FIGS. 5 to 7 guarantee identical coefficients of friction for contact between these coatings and the respective belt. In accordance with presumption, these coefficients of friction are less than the coefficient of friction for contact between the belt 80 and one of the rollers 71 and 86 and the coefficient of friction for contact between the belt 105 and the roller body 96.

In the situations illustrated in FIGS. 5 and 6 the coatings 72 and 87 each ensure minimization of the transverse force F_{q}. The base 76 and the base 91 each have the same shape and accordingly the same effect with respect to guidance of the belt 80. The design of the groove 90 is accompanied by the advantage, by comparison with the groove 75, that the coating 87 is arranged at the flanks 92 and 93 of the groove 90 whilst the flanks 77 and 78 of the groove 75 do not have a coating according to the invention. Since the belt 80 is thus exposed to a lower friction at the flank 92 than at the flank 77, the narrow side of the belt 80 is subjected to a lesser degree of wear at the roller 85 than at the roller 70.

The fact that the flanks 92 and 93 are inclined by the angle α relative to a plane arranged perpendicularly to the axis of rotation of the roller 85 is of particular advantage if the belt 80 is disposed under diagonal tension and comes into contact with one of the flanks. Due to the inclination of the flanks the narrow side of the belt 80 contacts the regions of the roller 85 adjacent to the groove 90 less lightly under the action of a diagonal tension by comparison with the case of α=0. The inclination of the flanks thus reduces the risk that the belt 80 leaves the groove 90 under diagonal tension. The belt is therefore guided more reliably and securely.

The conditions in the case of FIG. 7 differ from the situation according to FIG. 6 principally in that the base 101 of the groove 100 is convexly curved in the direction of the axis of rotation of the roller 95. The belt 105, under a tension in its longitudinal direction, adopts this curvature of the base 105 and is thus resiliently deformed in its transverse direction when running around the roller 95. Due to this deformation the belt tends to preferentially take up a position in which the belt 90 lies symmetrically with respect to the plane 102. The transverse force F_{q} is thereby reduced and the belt 105 is guided in particularly stable manner. Due to the fact that the flanks 103 and 104 are inclined by the angle β, the roller 95 has the same advantages, with respect to the guidance of belts disposed under diagonal tension, as the roller 85. In addition, the angle β is so selected that the narrow sides of the belt 105 are oriented parallel to the flanks 103 and 104, respectively, if the belt 105 should come into contact with one of these flanks when running around the roller 95. The belt 95 is thereby loaded at its sides by particularly low forces when it contacts the flanks 103 and 104. In the case of the roller 95 the friction-reducing action of the coating 97, the inclination of the flanks 103 and 104 (β greater than zero) and the curvature of the base 101 of the groove 100 thus form the basis for a particularly gentle guidance of the belt 105.

Since the rollers 70, 85 and 95 are provided with a friction-reducing coating, the traction is also reduced for belts guided around the rollers. The rollers 70, 85, and 95 are accordingly preferably usable as deflecting rollers.

The aforesaid considerations can be transferred analogously to elevators with twin cables as support means. There is known from European EP 1061172, by way of example, a twin cable which is made up from two synthetic fiber cables arranged in parallel and twisted in opposite directions of rotation. The two synthetic fiber cables are fixed at a spacing from one another by a common cable casing to be secure against twisting. Depending on the respective form of the cable casing the cross-section of the twin cable can be, for example, dumb-bell shaped. The cable casing can also form a flat surface in the region between the two synthetic fiber cables. A twin cable shaped in that manner can be guided at the surface of a roller in mechanically positive manner, for example in a groove which is adapted to the external shape of the cross-sectional surface of the cable casing. A twin cable with a dumb-bell shaped cross-sectional surface can be guided in mechanically positive manner in, for example, a double groove (known from EP 1096176). In order to achieve gentle guidance of the twin cable in the case of diagonal tension, the roller can be provided in the region of the groove with a friction-reducing coating according to the invention. The coating can be arranged at, for example, the flanks of the groove.

In the examples illustrated in FIGS. 1 to 7 exclusive use was made of rollers for guidance of the respective traction means. It may accordingly be noted that other bodies, for example, slide elements with slide surfaces for the traction means, can also be used for guidance of the traction means and these bodies can also be provided with a friction-reducing coating according to the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. In an elevator for transporting a load by a movable traction means connected with the load, wherein at least a section of the traction means is brought into contact with at least one roller in order to guide the traction means, the at least one roller comprising:
a body having a guide means with a contact surface for receiving a movable traction means having a round cross-section; and
a coating covering at least a portion of said contact surface wherein said coating has a first coefficient of friction for contact with the traction means that is less than a second coefficient of friction for contact between the traction means and an uncoated portion of said body.

2. The roller according to claim 1 wherein said guide means is formed as a groove in said body.

3. In an elevator for transporting a load by a movable traction means connected with the load, wherein at least a section of the traction means is brought into contact with at least one roller in order to guide the traction means, the at least one roller comprising:
a body having a groove with a flank formed therein, said groove having a contact surface for receiving a movable traction means; and
a coating covering at least a portion of said contact surface wherein said coating has a first coefficient of friction for contact with the traction means that is less than a second coefficient of friction for contact between the traction means and an uncoated portion of said body.

4. The roller according to claim 3 wherein said groove is configured to guide the traction means in diagonal tension.

5. The roller according to claim 3 wherein said contact surface is covered by said coating.

6. The roller according to claim 3 wherein said contact surface has an uncoated portion between coated portions for contact between said uncoated portion and the traction means.

7. The roller according to claim 6 wherein said groove has a base and said uncoated portion is said base.

8. The roller according to claim 5 wherein said flank is covered by said coating and the traction means can be brought into contact with said flank.

9. The roller according to claim 3 wherein said flank is covered by said coating.

10. The roller according to claim 3 wherein said groove has a generally semicircular cross-section forming said contact surface.

11. The roller according to claim 3 wherein said groove has a generally flat portion forming said contact surface.

12. The roller according to claim 3 wherein said groove has a generally convex portion forming said contact surface.

13. The roller according to claim 3 wherein the roller is a drive roller adapted to be connected to an elevator drive.

14. The roller according to claim 3 wherein said coating contains a lubricant being at least one of a dry lubricant and a wet lubricant.

15. The roller according to claim 14 wherein said dry lubricant is at least one of talcum, graphite powder, molybdenum disulfide, polytetrafluoroethylene (PTFE), lead (Pb), gold (Au), silver (Ag), boron trioxide (BO₃), lead oxide (PbO), zinc oxide (ZnO), copper oxide (Cu₂O) molybdenum trioxide (MoO₃), and titanium dioxide (TiO₂).

16. The roller according to claim 14 wherein said wet lubricant is at least one of animal, plant, petrochemical and/or synthetic oil or grease, glycerol, polybutene, polymer esters, polyolefines, polyglycols, silicone, soap, natural or synthetic wax, resin and/or tars with additives of organic or inorganic thickeners including organic polymers, polycarbamide, metal soaps, silicates, metal oxides, silicic acid, and organophilic bentonites.

17. The roller according to claim 3 wherein said body is made of one of steel, cast iron, polyamide, Teflon, aluminium, magnesium, non-ferrous metals, polypropylene, polyethylene, polyvinylchloride, polyimide, polyetherimide, ethylenepropylenediene monomer (EPDM) and polyetheretherketone (PEEK).

18. An apparatus for transporting a load comprising:
a movable traction means adapted to be connected to a load and being one of a cable and a belt;
a body having a guide means with a contact surface for receiving said movable traction means; and
a coating covering at least a portion of said contact surface wherein said coating has a first coefficient of friction in contact with said traction means that is less than a second coefficient of friction for contact between said traction means and an uncoated portion of said body.

19. The apparatus according to claim 18 wherein said traction means contains at least one of natural fibers, synthetic material fibers, and metallic wire.

20. The apparatus according to claim 19 wherein at least a portion of a surface of said traction means is formed of a sheathing surrounding said contains at least one of natural fibers, synthetic material fibers, and metallic wire.

21. The apparatus according to claim 20 wherein said sheathing is formed from an elastomer including one of a polyurethane of natural or synthetic rubber and silicon rubber.

22. An elevator comprising:
a movable traction means adapted to be connected to a load being at least one of an elevator car and a counterweight, said traction means adapted to support the load;
a body having a guide means with a contact surface receiving said movable traction means; and
a coating covering at least a portion of said contact surface wherein said coating has a first coefficient of friction in contact with said traction means that is less than a second coefficient of friction for contact between said traction means and an uncoated portion of said body.
